(19) United States
(12) Patent Application Publication
(10) Pub. No.: US 2024/0169460 A1
(43) Pub. Date: May 23, 2024

(54) BOARDING ASSISTANCE SYSTEM, BOARDING ASSISTANCE METHOD, AND RECORDING MEDIUM RECORDING PROGRAM

(71) Applicant: NEC Corporation, Minato-ku, Tokyo (JP)

(72) Inventors: Kosei KOBAYASHI, Tokyo (JP); Tetsuro HASEGAWA, Tokyo (JP); Hiroaki AMINAKA, Tokyo (JP); Kei YANAGISAWA, Tokyo (JP); Kazuki OGATA, Tokyo (JP)

(73) Assignee: NEC Corporation, Minato-ku, Tokyo (JP)

(21) Appl. No.: 18/283,020

(22) PCT Filed: Mar. 22, 2021
(86) PCT No.: PCT/JP2021/011765

§ 371 Date: Sep. 20, 2023

(51) Int. Cl. G06Q 50/40; G06Q 10/02; G06T 7/70; G06V 10/40; G06V 20/52; G06V 40/10; G08G 1/123

(52) U.S. Cl. CPC G06Q 50/40; G06Q 10/02; G06T 7/70; G06V 10/40; G06V 20/52; G06V 40/103; G08G 1/123; G06T 2207/30196; G06T 2207/30232

(57) ABSTRACT

A boarding assistance system includes a reception part for receiving a combination of information of a passenger vehicle which has been reserved by a user and information of the user who has reserved from a vehicle allocation system which allocates a passenger vehicle; an image acquisition part for acquiring a shot image of the user who has reserved by selecting any of the plurality of fixed-point cameras installed on a roadside based on the information of the user; and a display part for displaying information for identifying the user of the passenger vehicle on a predetermined display apparatus using the shot image of the user.

This application is a National Stage Entry of PCT/JP2021/011765 filed on Mar. 22, 2021, the contents of all of which are incorporated herein by reference, in their entirety.

### FIELD

The present invention relates to a boarding assistance system, a boarding assistance method, and a recording medium recording a program.

### BACKGROUND

Patent Literature (PTL) 1 discloses a vehicle allocation system which can prevent a trouble caused by a user forgetting to have made a vehicle allocation request to a vehicle allocation center from occurring. PTL 1 discloses that a user transmits a current location information of the user to an information terminal on an allocated vehicle through a vehicle monitoring system or directly. It is also described that the vehicle monitoring system transmits vehicle data such as appearance or color of a vehicle to be allocated and image date of a face of a driver, sound data of a voice of a driver, and video data such as landscape taken from a running vehicle (refer to paragraph 0128).

PTL 2 discloses a vehicle allocation service method which can easily use a taxi allocation service at an outside place not geographically informed, confirm promptly and accurately a detailed called position where a user is waiting by a taxi driver, and certainly provide a vehicle allocation service.

PTL 3 discloses a configuration including a server which transmits vehicle allocation information including a boarding location to both a user and an on-board terminal (refer to paragraph 0051). PTL 4 discloses an autonomous driving vehicle including an image analysis part which analyzes images around a vehicle allocation location taken by using a plurality of cameras and dynamically sets a vehicle allocation area R according to road conditions around a vehicle allocation point.
PTL 1: Japanese Patent Kokai Publication No: 2003-067890
PTL 2: Japanese Patent Kokai Publication No: 2002-32897
PTL 3: Japanese Patent Kokai Publication No: 2019-067012
PTL 4: Japanese Patent Kokai Publication No: 2020-097850

### SUMMARY

The following analysis has been made by the present inventors. There is a case where, when a taxi is picking up a passenger, there are a plurality of passengers at a pick-up point whereby it is difficult to identify the passenger of own vehicle. In this regard, in PTL 1 and PTL 2, there is a problem that information of a user cannot be acquired when a user does not carry an information terminal.

It is an object of the present invention to provide a boarding assistance system, a boarding assistance method, and a recording medium recording a program which can facilitate identification of passengers at a pick-up point.

According to a first aspect, there is provided a boarding assistance system, which can acquire one or more images from a plurality of fixed-point cameras installed on a roadside, including: a reception part for receiving a combination of information of a passenger vehicle which has been reserved by a user and information of the user who has reserved from a vehicle allocation system which allocates a passenger vehicle; an image acquisition part for acquiring a shot image of the user who has reserved by selecting any of the fixed-point cameras based on the information of the user; and a display part for displaying information for identifying the user of the passenger vehicle on an on-board terminal of the passenger vehicle using the shot image of the user.

According to a second aspect, there is provided a boarding assistance method, including: by a computer which can acquire one or more images from a plurality of fixed-point cameras installed on a roadside, receiving a combination of information of a passenger vehicle which has been reserved by a user and information of the user who has reserved from a vehicle allocation system which allocates a passenger vehicle; acquiring a shot image of the user who has reserved by selecting any of the fixed-point cameras based on the information of the user; and displaying information for identifying the user of the passenger vehicle on an on-board terminal of the passenger vehicle using the shot image of the user. This method is associated with a certain machine, which is a computer which can acquire one or more images from a plurality of fixed-point cameras installed on a roadside.

According to a third aspect, there is provided a computer program (hereinafter, a “program”) for realizing the functions of the above boarding assistance system. This computer program is inputted to a computer apparatus via an input device or a communication interface from outside, is stored in a storage device, and drives a processor in accordance with predetermined steps or processing. In addition, this program can display, as needed, a processing result including an intermediate state per stage on a display device or can communicate with outside via the communication interface. As an example, the computer apparatus for this purpose typically includes a processor, a storage device, an input device, a communication interface, and as needed, a display device, which can be connected to each other via a bus. In addition, this program can be recorded in a computer-readable (non-transitory) storage medium. That is to say, the present invention can be realized by a computer program product.

According to the present invention, it is possible to facilitate identification of passengers at a pick-up point.

### BRIEF DESCRIPTION OF DRAWINGS

FIG. 1 is a diagram illustrating a configuration according to an example embodiment of the present invention.

FIG. 2 is a diagram illustrating an operation according to the example embodiment of the present invention.

FIG. 3 is a diagram illustrating a system configuration according to a first example embodiment of the present invention.

FIG. 4 is a flowchart illustrating an operation of an information processing apparatus according to the first example embodiment of the present invention.

FIG. 5 is a diagram illustrating a system configuration according to a second example embodiment of the present invention.

FIG. 6 is a flowchart illustrating an operation of an information processing apparatus according to the second example embodiment of the present invention.

FIG. 7 is a diagram illustrating a system configuration according to a third example embodiment of the present invention.

FIG. 8 is a flowchart illustrating an operation of an information processing apparatus according to the third example embodiment of the present invention.

FIG. 9 is a diagram illustrating an operation of an information processing apparatus according to the third example embodiment of the present invention.

FIG. 10 is a diagram illustrating a system configuration according to a fourth example embodiment of the present invention.

FIG. 11 is a flowchart illustrating an operation of an information processing apparatus according to the fourth example embodiment of the present invention.

FIG. 12 is a diagram illustrating an operation of an information processing apparatus according to the fourth example embodiment of the present invention.

FIG. 13 is a diagram illustrating an operation of an information processing apparatus according to the fourth example embodiment of the present invention.

FIG. 14 is a diagram illustrating a system configuration according to a fifth example embodiment of the present invention.

FIG. 15 is a flowchart illustrating an operation of an information processing apparatus according to the fifth example embodiment of the present invention.

FIG. 16 is a diagram illustrating a system configuration according to a sixth example embodiment of the present invention.

FIG. 17 is a diagram illustrating a configuration of a computer which can be configured as a boarding assistance system according to the present invention.

### EXAMPLE EMBODIMENTS

First, an outline of an example embodiment of the present invention will be described with reference to drawings. Note, in the following outline, reference signs of the drawings are denoted to each element as an example for the sake of convenience to facilitate understanding and description of this outline is not intended to limit the present invention to any mode shown in the drawings or any limitation. An individual connection line between blocks in the drawings, etc., referred to in the following description includes both one-way and two-way directions. A one-way arrow schematically illustrates a principal signal (data) flow and does not exclude bidirectionality. In addition, although a port or an interface is present at an input/output connection point of an individual block in the relevant drawings, illustration of the port or the interface is omitted. A program is executed via a computer apparatus, and the computer apparatus includes, for example, a processor, a storage device, an input device, a communication interface, and as needed, a display device. In addition, this computer apparatus is configured such that the computer apparatus can communicate with its internal device or an external device (including a computer) via the communication interface in a wired or wireless manner.

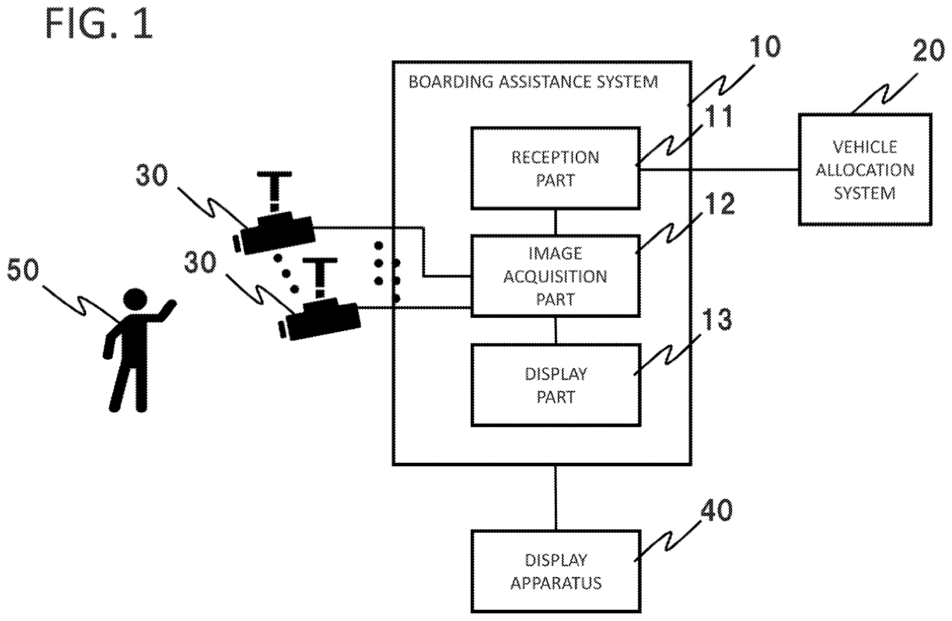

In an example embodiment, as illustrated in FIG. 1, the present invention can be realized by a boarding assistance system 10 which is connected to a plurality of fixed-point cameras 30, a vehicle allocation system 20, and a display apparatus 40.

The plurality of fixed-point cameras 30 are installed on a roadside and can shoot a passenger vehicle which is picking up a passenger. Installed positions of the plurality of fixed-point cameras 30 are considered to be main facilities, intersections and so on which are frequently designated as pick-up points, but not limited thereto.

The vehicle allocation system 20 is a vehicle allocation system of a taxi company or that of an autonomous driving vehicle which allocates the passenger vehicle.

The display apparatus 40 is an apparatus on which information for identifying a user of a passenger vehicle which the boarding assistance system 10 creates is shown. Types of the display apparatus are considered to be an on-board apparatus of a passenger vehicle, a management terminal of a taxi company or that of an autonomous driving vehicle, and so on.

The boarding assistance system 10 includes a reception part 11, an image acquisition part 12, and a display part 13. The reception part 11 receives a combination of information of a passenger vehicle which has been reserved by a user and information of the user who has reserved from a vehicle allocation system 20. The image acquisition part 12 acquires a shot image of the user who has reserved by selecting any of the fixed-point cameras based on the information of the user. The display part 13 displays information for identifying the user of the passenger vehicle on the display apparatus 40 using the shot image of the user.

Note, as a mechanism to acquire an image of a corresponding user from a plurality of fixed-point cameras 30 based on the information of the user of the passenger vehicle by the image acquisition part 12, following methods may be considered to be used. (1) There is a method in which an image of a person shot by a fixed-point camera 30 is matched to a face, walking (appearance of walking) or the like of the user registered in advance.
(2) There is a method in which information including position information from a terminal or the like which a user of a passenger vehicle carries is received and the fixed-position camera is selected based on its position information. For example, the position information acquired by GPS (Global Positioning System), serving cell information acquired by base stations of a wireless communication network, and so on can be used as this position information.
(3) There is a method in which an explicit shooting request is received using a terminal and so on which a user carries from the user of a passenger vehicle and the user is shot by a fixed-point camera 30 which can shoot.

In addition, a method for acquiring an image from the fixed-point camera 30 is not only limited to a mode in which an image is directly received from the fixed-point camera 30 but also it is possible to employ a mode in which an image is acquired from a storage device which temporarily stores images shot by the fixed-point cameras 30. The fixed-point cameras 30 and the image acquisition part 12 can be connected to each other using various networks. As an example, the fixed-point cameras 30 and the image acquisition part 12 may be connected through a wired line. As another example, the fixed-point cameras 30 and the image acquisition part 12 may be connected through a wireless line such as LTE, 5G, a wireless LAN or the like.

The boarding assistance system 10 as configured above receives a combination of information of a passenger vehicle which has been reserved by a user and information of the user who has reserved from a vehicle allocation system 20. Then, the boarding assistance system 10 acquires a shot image of the user who is moving to a boarding location based on the reservation by selecting any of the fixed-point cameras based on the information of the user. Furthermore, the boarding assistance system 10 displays information for identifying the user of the passenger vehicle on a predetermined display apparatus 40 using the shot image of the user.

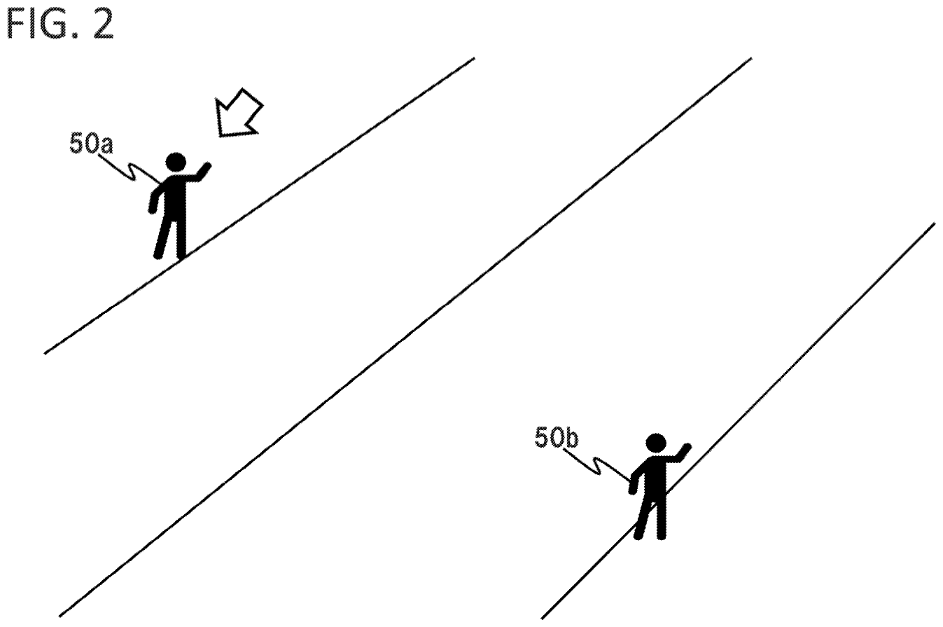

As the information for identifying the user, an appearance image of the user can be used. For example, as shown in FIG. 2, an image of an entire body of the user can be used which is an image of the user shot at a position apart by a predetermined or more distance. In the case where there exist a plurality of persons 50a and 50b in one image, it is preferable to add information to identify a target user 50a using an arrow or the like as shown in FIG. 2. Note, it is just an example to use an image of an entire body as an appearance image and a partial image such as a face, an upper body and so on may be trimmed from an image of an entire body and used. Furthermore, as another mode of information for identifying a user, feature information of a user which is recognized from an image of a user of a passenger vehicle can be used. Concrete example of this feature information will be described in a second example embodiment.

As a result, even if a plurality of persons are waiting at a pick-up point, a driver of a passenger vehicle can easily identify a person to be boarded.

### First Example Embodiment

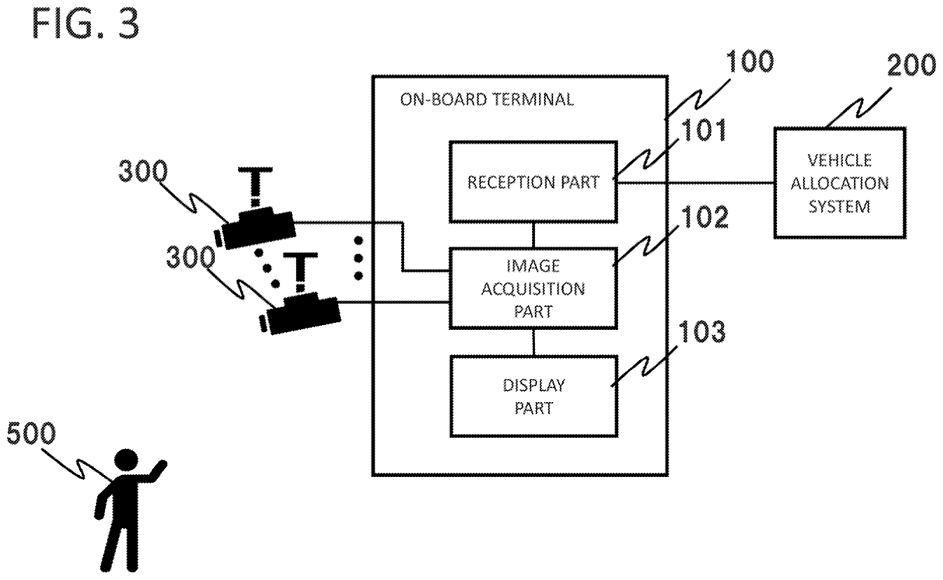

Next, a first example embodiment of the present invention will be described in detail with reference to drawings. FIG. 3 is a diagram illustrating a system configuration according to the first example embodiment of the present invention. With reference to FIG. 3, an on-board terminal 100 which is connected to a plurality of fixed-point cameras 103 installed on a roadside and a vehicle allocation system 200 is shown.

The vehicle allocation system 200 is a system which receives a reservation of a passenger vehicle in which a date and time, a pick-up point and so on are designated from a user of a passenger vehicle and instructs allocation of the passenger vehicle to an on-board terminal of the passenger vehicle. In addition, the vehicle allocation system 200 according to the present example embodiment incudes a function to transmit information of the user who has reserved to an on-board terminal 100 of the passenger vehicle. Note, it is assumed that destination information (a terminal ID, an IP address, a mail address, and so on) to transmit information to the on-board terminal 100 of the passenger vehicle is set to the vehicle allocation system 200 in advance.

The on-board terminal 100 includes a reception part 101, an image acquisition part 102, and a display part 103. The reception part 101 receives information of a user of own vehicle from the vehicle allocation system 200. “Information of a user” is information which can identify a user and is extracted from an image shot by any of a plurality of fixed-point cameras 300. For example, an ID of a user, face image information thereof and so on can be used.

The image acquisition part 102 selects any of a plurality of fixed-point cameras 300 based on the information of the user and acquires a shot image of a user from the selected fixed-point camera 300. For example, in a case where face image information is used as “information of a user”, the image acquisition part 102 trims a face area of a person in the image shot by the fixed-point camera 300 and performs face authentication by matching the face area to a face image of the corresponding user registered in advance. Furthermore, it is also assumed that a fixed-point camera 300 side has a function to trim a face area of a person in the image at, perform face authentication and tag the image. In this case, the image acquisition part 102 can also identify a user of a passenger vehicle by matching the tag to an ID of the user.

The display part 103 functions as a facility to display the information for identifying the user on a display apparatus (not shown) of the on-board terminal 100 using the image of the user acquired by the image acquisition part 102.

The on-board terminal 100 as described above can be configured by installing a computer program (so called “Application”, or “App”) which realizes functions corresponding to the reception part 101, the image acquisition part 102, and the display part 103 as described above to a car navigation system or a driving assistant system mounted on a passenger vehicle. Furthermore, as another example embodiment, a boarding assistance system can be realized as a server which causes an on-board terminal to display the information for identifying the user (see a sixth example embodiment, hereinafter).

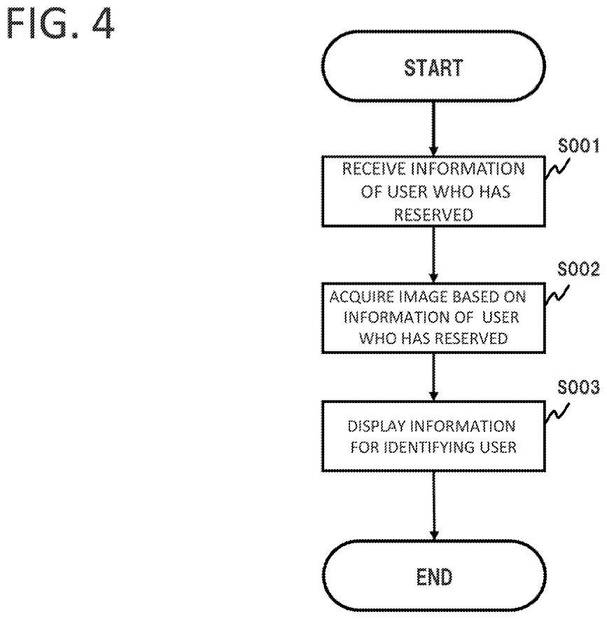

Next, an operation of the present example embodiment will be described with reference to drawings in detail. FIG. 4 is a flowchart illustrating an operation of an on-board terminal 100 according to the first example embodiment of the present invention. With reference to FIG. 4, first, the on-board terminal 100 receives information of a user who has reserved from the vehicle allocation system 200 (step S001).

The on-board terminal 100 selects any of a plurality of fixed-point cameras 300 based on the information of the user and acquires a shot image from a selected fixed-point camera 300 (step S002).

The on-board terminal 100 displays the information for identifying the user on a display apparatus (not shown) of the on-board terminal 100 using the image of the user acquired by the image acquisition part 102 (step S003).

According to the on-board terminal 100 which operates as described above, it becomes possible to provide a driver of a passenger vehicle with information for identifying a user to be boarded on own vehicle. For example, as shown in FIG. 2, by providing an appearance image of the user, it becomes possible for a driver of a passenger vehicle to accurately identify a user to be boarded on own vehicle using the appearance image of the user at a pick-up point.

### Second Example Embodiment

Next, a second example embodiment which provides feature information (clothing, a wearing, a hairstyle, a gender, an estimated age, a body height, presence or absence of a baggage or an accompanier) of a user recognized by an image of a user will be described. Because a configuration and an operation according to the second example embodiment are substantially the same as those of the first example embodiment, a difference thereof will be mainly described below.

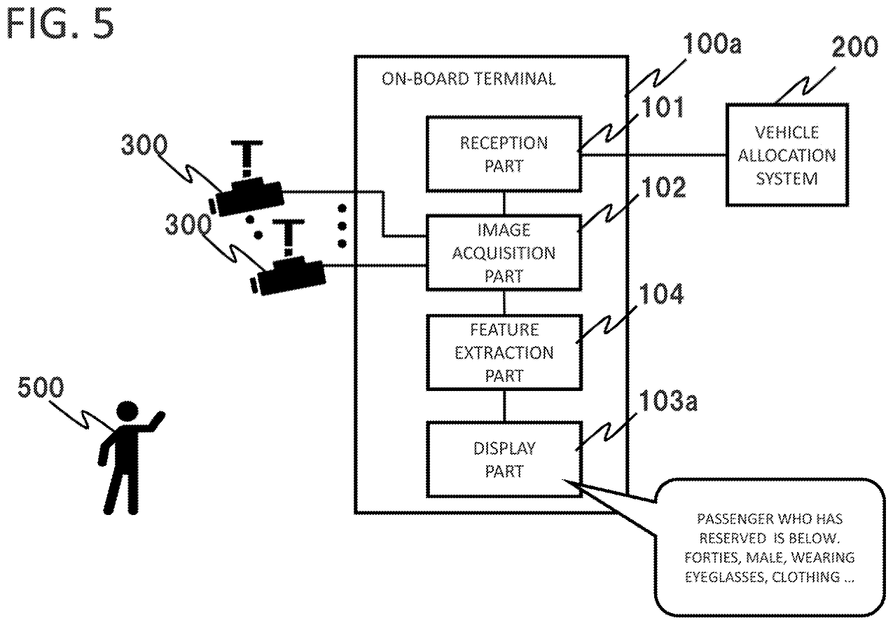

FIG. 5 is a diagram illustrating a system configuration according to the second example embodiment of the present invention. A difference from the first example embodiment is that it is configured that a feature extraction part 104 is added to an on-board terminal 100a and a display part 103a displays feature information of a user extracted by the feature extraction part 104.

In the present example embodiment, an image of a user acquired by the image acquisition part 102 is inputted to the feature extraction part 104. The feature extraction part 104 recognizes one or more features of a user from an image of a user and outputs it to the display part 103a. As a method to recognize one or more feature from an image of a user, a method using a classifier which has been created by machine learning in advance can be used. For example, the feature extraction part 104 recognizes at least one or more of clothing, a wearing (eyeglasses and a mask), a hairstyle, a gender, an estimated age, a body height, presence or absence of a baggage or an accompanier from an image of a user.

The display part 103a displays feature information of a user extracted by the feature extraction part 104 on a display apparatus (not shown) of an on-board terminal 100a. For example, as shown in FIG. 5, the display part 103a displays an estimated age (generation), an estimated gender, a wearing (eyeglasses), clothing, and so on of a user on a display apparatus (not shown) of the on-board terminal 100a.

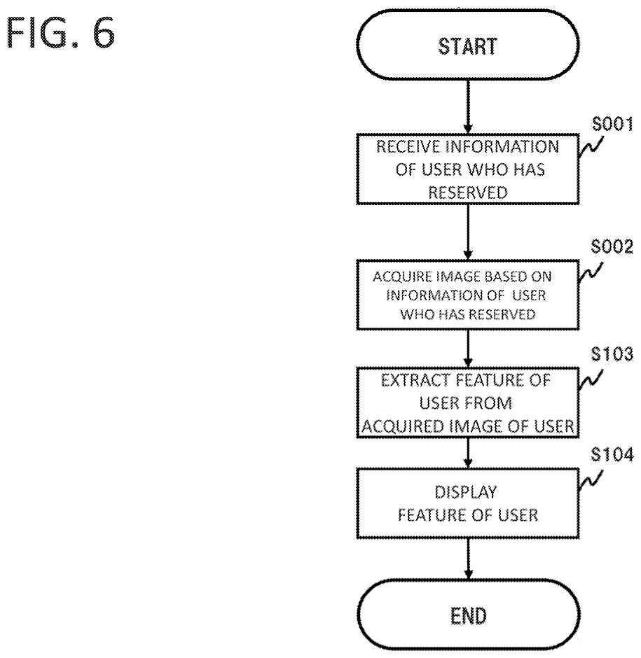

Next, an operation of the present example embodiment will be described with reference to drawings in detail. FIG. 6 is a flowchart illustrating an operation of an on-board terminal 100a according to the present example embodiment. Because operations at step S001 and step S002 of FIG. 6 are the same as those of the first example embodiment, description will be omitted.

At step S103, the on-board terminal 100a extracts one or more features of a user from an image of a user.

Then, at step S104, the on-board terminal 100a displays the one or more features of the user on a display apparatus (not shown).

As described above, according to the present example embodiment, identification of a user is further facilitated by providing feature information of the user recognized from an image of the user. Of course, an image of a user itself may be displayed along with feature information in the same way as that of the first example embodiment.

### Third Example Embodiment

Next, a third example embodiment in which a waiting location of a user is transmitted as information for identifying a user will be described with reference to drawings in detail. Because a configuration and an operation according to the third example embodiment are substantially the same as those of the first example embodiment, a difference thereof will be mainly described below.

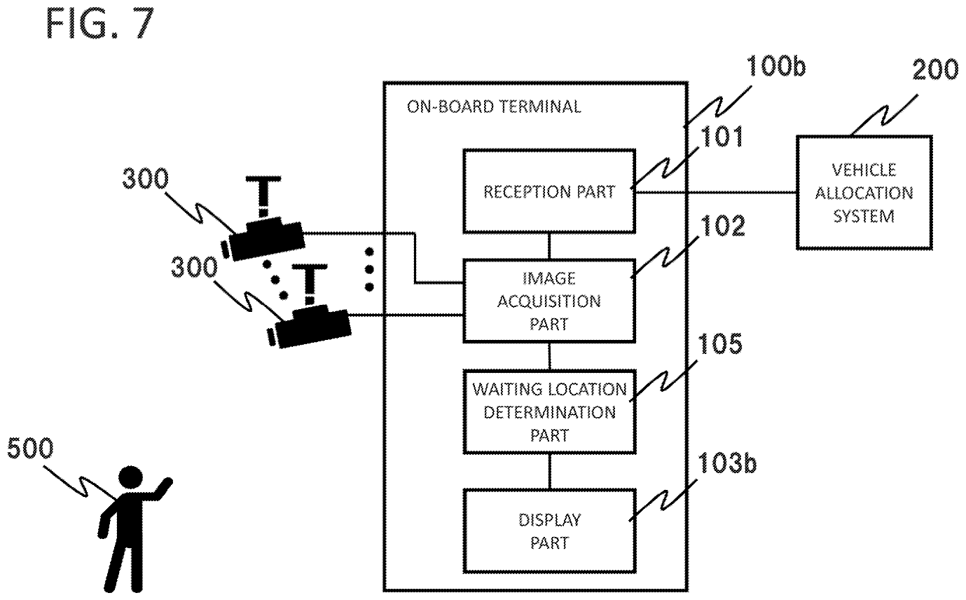

FIG. 7 is a diagram illustrating a system configuration according to the third example embodiment of the present invention. A difference from the first example embodiment is that it is configured that a waiting location determination part 105 is added to an on-board terminal 100b and a display part 103b displays a waiting location of a user identified by the waiting location determination part 105.

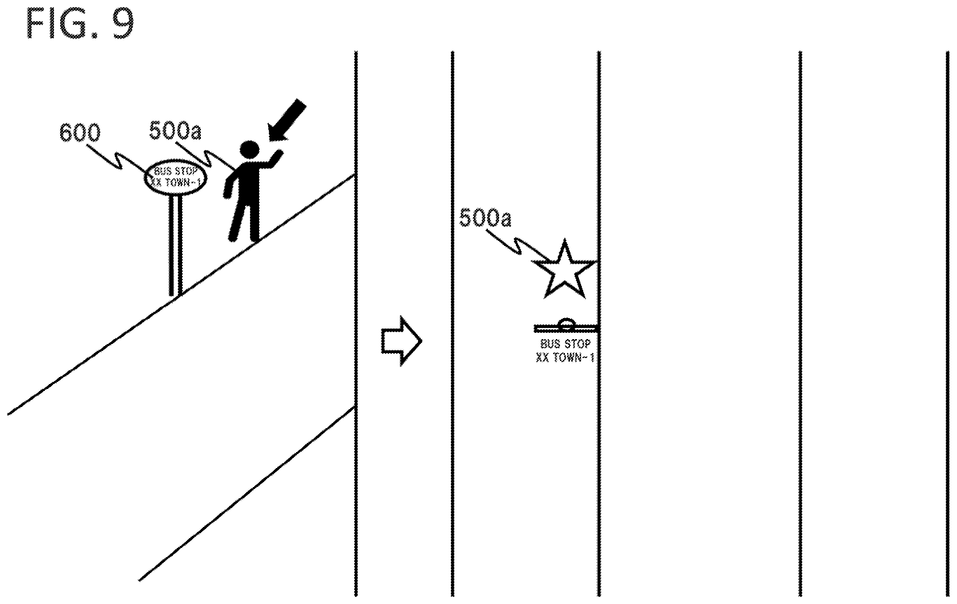

In the present example embodiment, an image of a user acquired by the image acquisition part 102 is inputted to the waiting location determination part 105. The waiting location determination part 105 identifies a waiting location of a user from an image of a user. Then, the waiting location determination part 105 creates a map indicating a waiting location of a user which has been identified and outputs it to the display part 103b. For example, when an image of a user as shown in a left part of FIG. 9 is acquired, the waiting location determination part 105 identifies a detailed waiting location of a user as shown in a right part of FIG. 9 from a location of the fixed-point camera, a position of a user in the image, a landmark 600, and so on and plots it on the map. Note, a map used here may be the same map as that of a car navigation system.

The display part 103b displays a map showing a waiting location of a user identified by the waiting location determination part 105 on a display apparatus (not shown) of the on-board terminal 100b.

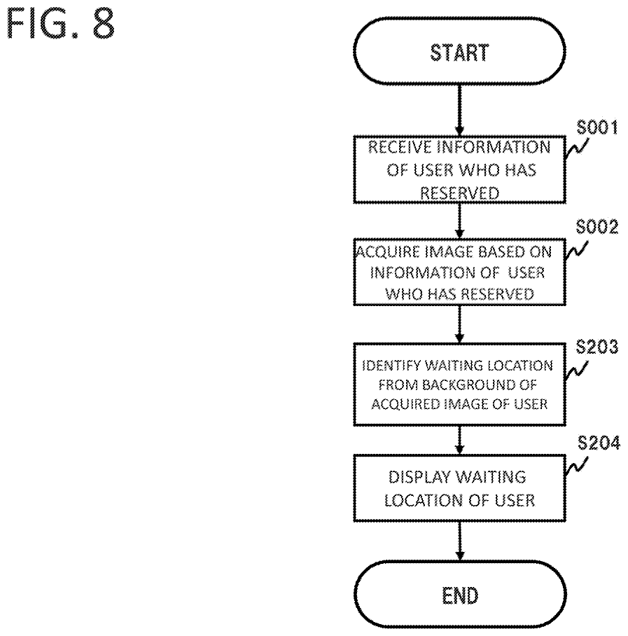

Next, an operation of the present example embodiment will be described with reference to drawings in detail. FIG. 8 is a flowchart illustrating an operation of the on-board terminal 100b according to the present example embodiment. Because operations at step S001 and step S002 of FIG. 8 are the same as those of the first example embodiment, description will be omitted.

At step S203, the on-board terminal 100b identifies a waiting location of a user from an image of the user.

Then, at step S204, the on-board terminal 100b displays a map showing a waiting location of a user on a display apparatus (not shown) (see a right part of FIG. 9).

As described above, according to the present example embodiment, identification of a user can be further facilitated by providing a waiting location of a user recognized from an image of the user. Of course, an image of a user itself may be displayed along with a waiting location in the same was as that of the first example embodiment. In this case, information as shown in a left part of FIG. 9 will be displayed on a display apparatus (not shown) of the on-board terminal 100b.

### Fourth Example Embodiment

Next, a fourth example embodiment in which a boarding location to which the user is heading is predicted and provided as information for identifying a user will be described with reference to drawings in detail. Because a configuration and an operation according to the fourth example embodiment are substantially the same as those of the first example embodiment, a difference thereof will be mainly described below.

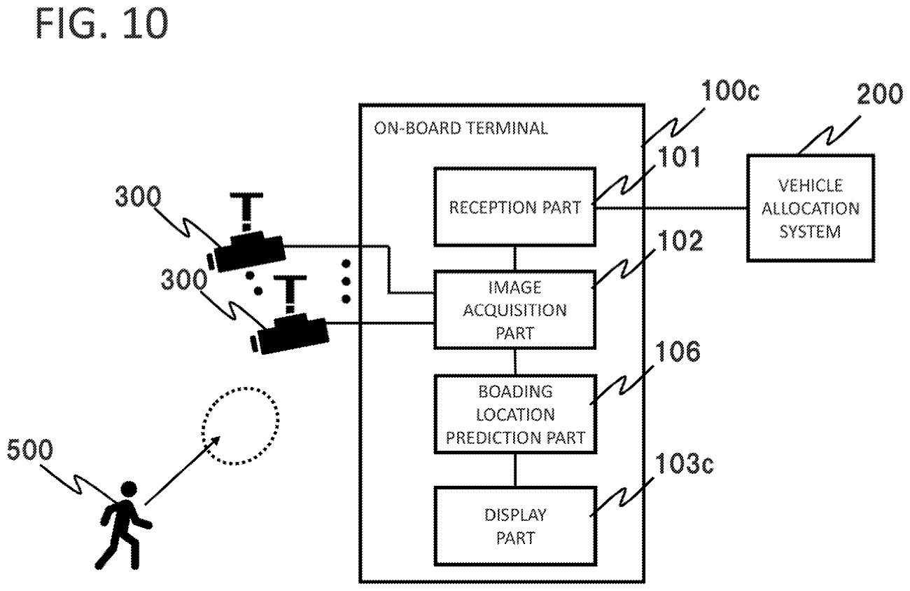

FIG. 10 is a diagram illustrating a system configuration according to the fourth example embodiment of the present invention. A difference from the first example embodiment is that it is configured that a boarding location prediction part 106 is added to an on-board terminal 100c and a display part 103c displays a boarding location of a user predicted by the boarding location prediction part 106.

In the present example embodiment, an image of a user acquired by the image acquisition part 102 is inputted to the boarding location prediction part 106. The boarding location prediction part 106 predicts a boarding location to which a user is heading based on the location of the fixed-point camera and an approaching direction (travelling direction) of the user to the boarding location recognized from a shot image of the user. Then, the boarding location prediction part 106 outputs the predicted boarding location of the user to the display part 103c. For example, in a case where a road includes a traffic lane A heading to one direction and a traffic lane B heading to an opposite direction from the traffic lane A, it is predicted which probability of a boarding location of a user is higher, a sidewalk of the traffic lane A or that of the traffic lane B. Furthermore, as another example, in a case where a user is approaching to a boarding location from an east side using a sidewalk along a main road, the boarding location prediction part 106 predicts an appropriate waiting location for a passenger vehicle in a left side of the sidewalk in a travelling direction of the user along the road based on a surrounding traffic state and a traffic rule. A concrete example of prediction by the boarding location prediction part 106 may be described with reference to drawings in detail later.

The display part 103c displays a boarding location which has been predicted by the boarding location prediction part 106 on the display apparatus (not shown) of the on-board terminal 100c. The predicted boarding location may be displayed along with a map. Note, a map used here may be the same map as that of a car navigation system.

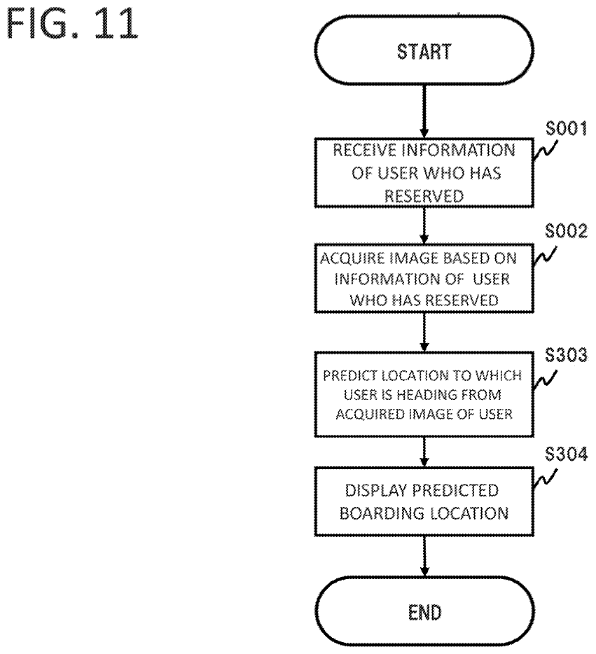

Next, an operation of the present example embodiment will be described with reference to drawings in detail. FIG. 11 is a flowchart illustrating an operation of the on-board terminal 100c according to the present example embodiment. Because operations at step S001 and step S002 of FIG. 11 are the same as those of the first example embodiment, description will be omitted.

At step S303, the on-board terminal 100c predicts a boarding location of a user from the location of the fixed-point camera 300 and an image of the user.

Then, at step S304, the on-board terminal 100c displays a boarding location of the user on a display apparatus (not shown).

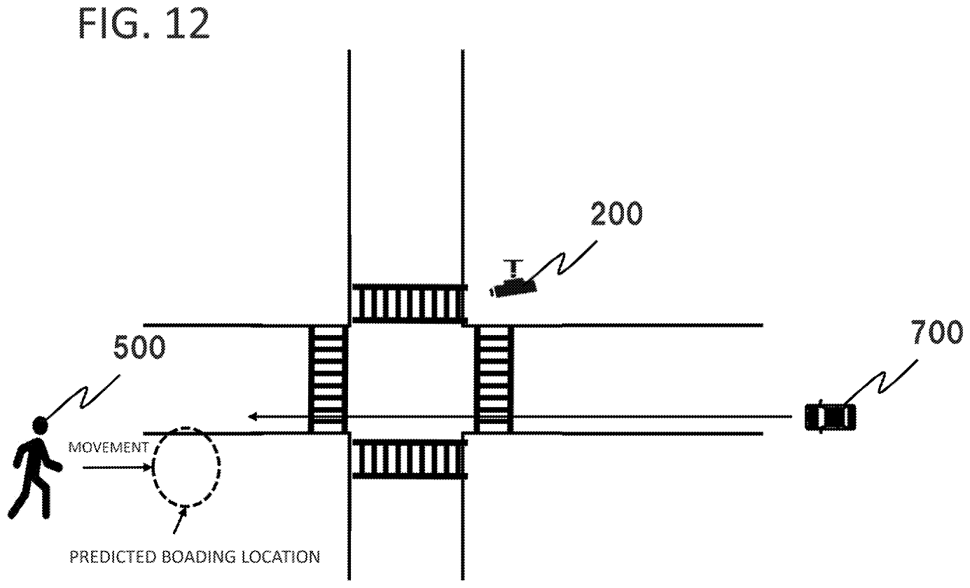

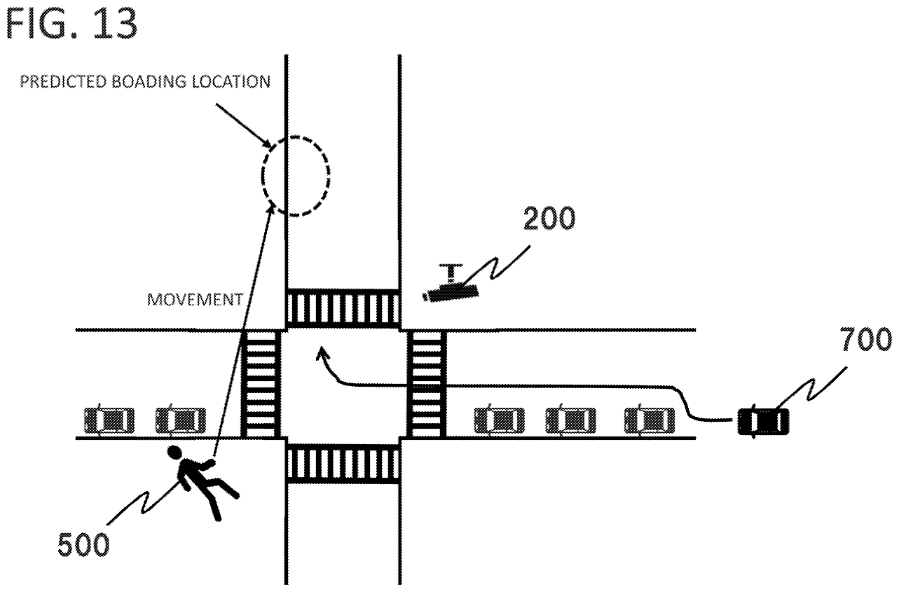

An operation of the above on-board terminal 100c will be described using FIG. 12 and FIG. 13. For example, as shown in FIG. 12, in a case where a user 500 is approaching around an intersection which is a pick-up point from a west side (a left side of FIG. 12), the boarding location prediction part 106 predicts a boarding location in the following way. First, areas on a road heading to an intersection from a west side of FIG. 12 are selected and a location among them at which a vehicle can safely stop and which does not violate a traffic rule is identified. In the example as shown in FIG. 12, a location which is in front of a left of the intersection and apart from the intersection by a predetermined distance is predicted as a boarding location. This is because a vehicle turning left and so on may be obstructed if a vehicle stops beyond an intersection, and it is not allowed to park a vehicle at an intersection and within 5 meters from edges thereof under the Japanese traffic rule.

Furthermore, the boarding location prediction part 106 may predict a boarding location taking account of a traffic state near an intersection. For example, as shown in FIG. 13, in a case where a left line (a right side of FIG. 13) near beyond an intersection which is a boarding location is congested and a user 500 is heading to a sidewalk of a north side (an upper side of FIG. 13) of the intersection, the boarding location prediction part 106 predicts that the user 500 is boarding at the north side of (an upper side of FIG. 13) of the intersection.

In both cases as shown in FIG. 12 and FIG. 13, a driver of a passenger vehicle 700 who knows a boarding location can go to a location at which the user 500 is boarding and stop the passenger vehicle 700. As a result, it makes possible for the user 500 to board smoothly. Furthermore, in a more preferred mode, it is preferable that the on-board terminal 100c also notifies the user 500 of the predicted boarding location through the vehicle allocation system 200. If the user 500 goes towards the boarding location and stops there, boarding of the user can be further facilitated.

As described above, according to the present example embodiment, identification of a user can be further facilitated by providing a driver of the passenger vehicle 700 with a boarding location of a user through a display apparatus. Of course, an image and feature information of a user may be provided along with a boarding location in the same way as those of the first and second example embodiments.

### Fifth Example Embodiment

Next, a fifth example embodiment in which in which both a boarding location to which the user is heading and an arrival time thereto are predicted and provided as information for identifying a user will be described with reference to drawings in detail. Because a configuration and an operation according to the fifth example embodiment are substantially the same as those of the first example embodiment, a difference thereof will be mainly described below.

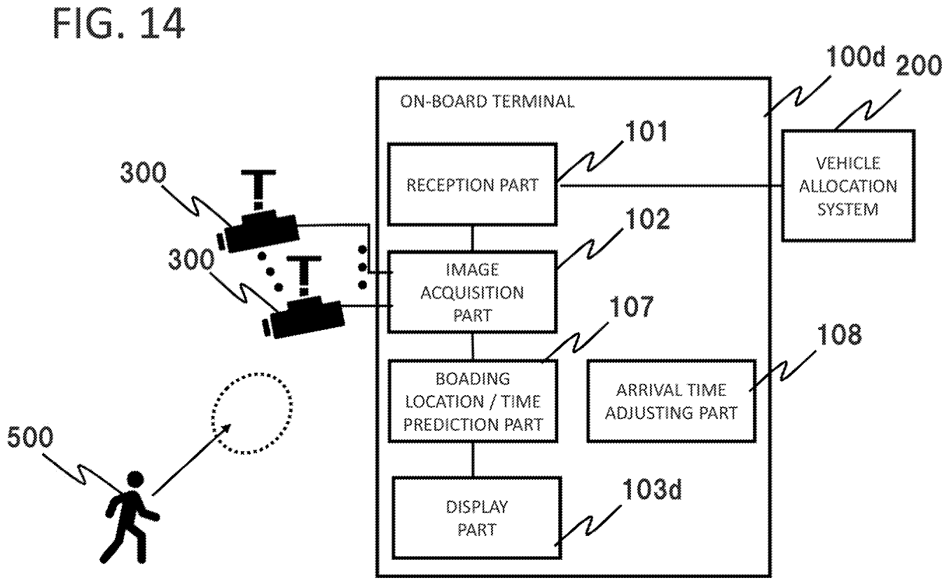

FIG. 14 is a diagram illustrating a system configuration according to a fifth example embodiment of the present invention. A difference from the first example embodiment is that a boarding location/time prediction part 107 and an arrival time adjusting part 108 are added to an on-board terminal 100d. Furthermore, a second difference from the first example embodiment is that display part 103d is configured to display a boarding location and arrival time of a user predicted by the boarding location/time prediction part 107.

In the present example embodiment, an image of a user acquired by the image acquisition part 102 is inputted to the boarding location/time prediction part 107. The boarding location/time prediction part 107 predicts an arrival time to a boarding location of a user based on the location of the fixed-point camera 300 and a time at which the user has been shot by the fixed-point camera 300. Furthermore, in a case where a further high precision arrival time is predicted, the boarding location/time prediction part 107 may predict a boarding location to which a user is heading and an arrival time thereto by recognizing an approaching direction of the user to the boarding location and a velocity thereof from an image of the user. Then, the boarding location/time prediction part 107 outputs the predicted boarding location of the user and the predicted arrival time thereof to the display part 103d.

The display part 103d displays the boarding location of the user and the arrival time thereof predicted by the boarding location/time prediction part 107 on a display apparatus (not shown) of the on-board terminal 100d.

The arrival time adjusting part 108 compares the predicted arrival time of the user predicted as above with a predicted arrival time of own vehicle and, for example, performs an adjustment processing of an arrival time if it will arrive too early before the predicted arrival time as it continues to go like this. As an adjustment processing of the arrival time, adjustment of a speed of own vehicle (slowing down the speed) or a change of a route (circumvention and so on), and so on may be considered. Furthermore, as another method of this adjustment processing of the arrival time, it is considered to ask a traffic control center of traffic light machines and so on to adjust control parameters of traffic light machines. This method may especially effective in a case where lights of the traffic light machines on the route are controlled to be bule, and so on, when it is expected for own vehicle to arrive there very late after the predicted arrival time of the user as a result of comparison of the predicted arrival time of the user with a predicted arrival time of own vehicle.

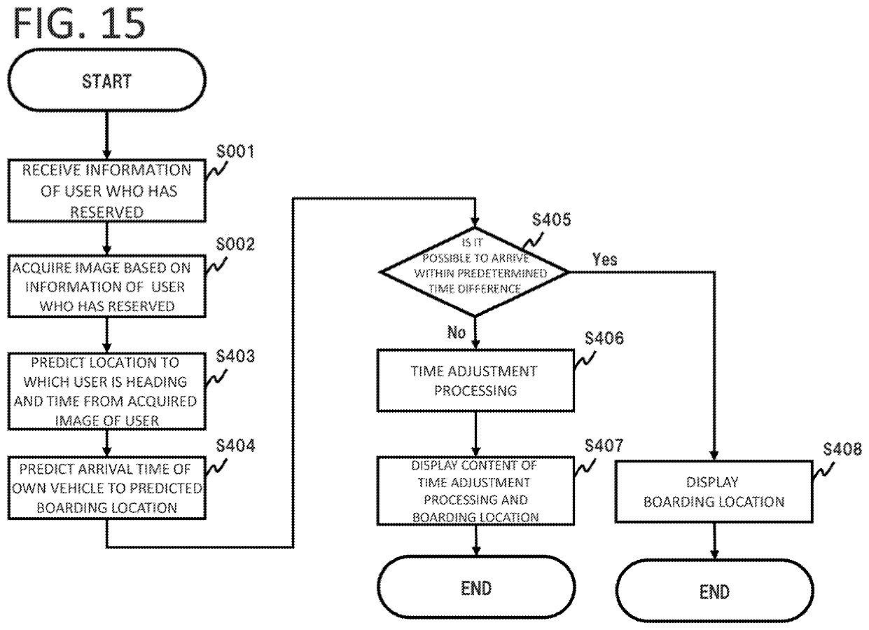

Next, an operation of the present example embodiment will be described with reference to drawings in detail. FIG. 15 is a flowchart illustrating an operation of an on-board terminal 100d according to the present example embodiment. Because operations at step S001 and step S002 of FIG. 15 are the same as those of the first example embodiment, description will be omitted.

At step S403, the on-board terminal 100d predicts a boarding location of a user and an arrival time thereof from an image of the user.

Next, the on-board terminal 100d predicts an arrival time of own vehicle to the boarding location (step S404).

Next, the on-board terminal 100d compares the two arrival times and checks whether or not it is possible to arrive within a predetermined time difference (step S405). As a result of the checking, if it is determined that it is possible to arrive within a predetermined time difference, the on-board terminal 100d displays the boarding location of the user on a display apparatus (not shown) (step S408).

On the other hand, as a result of the checking, if it is determined that it is not possible to arrive within a predetermined time difference, the on-board terminal 100d performs the adjustment processing of the arrival time as described above (step S406). Thereafter, the on-board terminal 100d displays a content of the adjustment processing of the arrival time and the boarding location of the user on a display apparatus (not shown) (step S407).

As described above, the on-board terminal 100d of the present example embodiment performs an adjustment processing of an arrival time in such a way as to arrive on the arrival time in addition to predicting a boarding location of a user. As a result, a driver of a passenger vehicle can easily identify a user who is in the location at the arrival time as a user of own vehicle.

### Sixth Example Embodiment

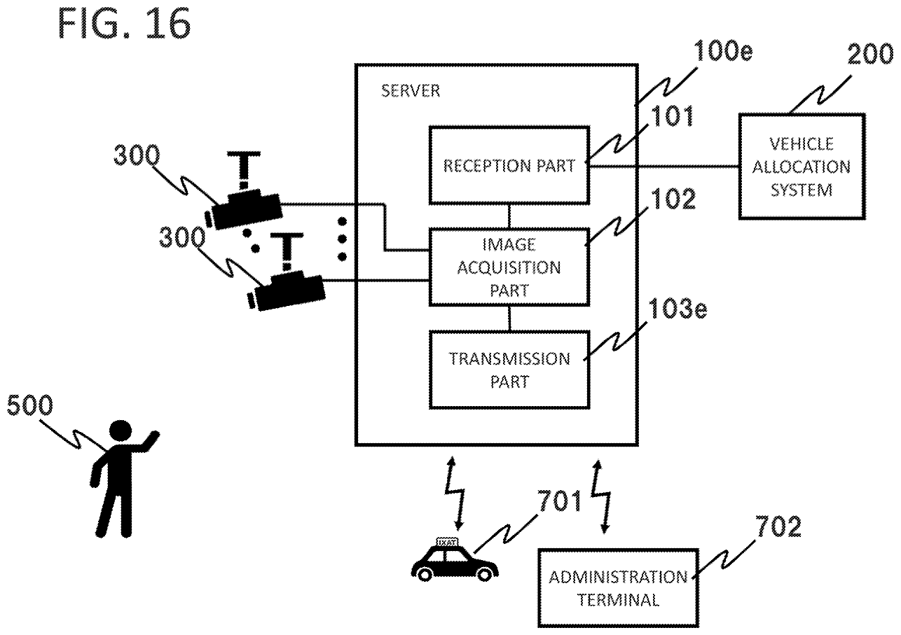

In the first to fifth example embodiments as described above, examples of configuring boarding assistance systems using on-board terminals are described. A boarding assistance system, however, can be configured by a server providing an on-board terminal with information. FIG. 16 is a diagram illustrating a system configuration according to a sixth example embodiment of the present invention including a server 100e. The server 100e may be a server created on a cloud or an MEC (Multi-access Edge Computing) server.

With reference to FIG. 16, a server 100e which is connected to a plurality of fixed-point cameras 300 and a vehicle allocation system 200. A reception part 101 and an image acquisition part 102 of the server 100e are the same as those of the first example embodiment, description will be omitted. A transmission part 103e of the server 100e transmits information for identifying a user 500 to an on-board terminal of a passenger vehicle 700 or an administration terminal 702 of a taxi company.

An on-board terminal 701 or the administration terminal 702 which has received information for identifying a user from the server 100e displays the information for identifying the user 500 on a display apparatus (not shown). Therefore, the server 100e includes display facility for displaying the information for identifying the user on a predetermined display apparatus using an image of the user. Note, when the administration terminal 702 is used as a display, a combination of information of a passenger vehicle and the information for identifying the user may be displayed.

According to the present example embodiment, there is an advantage that a computer program (so called “application”, “App”) is not necessarily be installed to an on-board terminal in advance in addition to the same effect of the first example embodiment. Of course, the sixth example embodiment can be modified to a configuration in which feature information of a user, a waiting location, a predicted boarding location, a predicted arrival time, and so on are provided as information for identifying a user in the same way as those of the second to fifth example embodiment.

The exemplary embodiments of the present invention have been described as above, however, the present invention is not limited thereto. Further modifications, substitutions, or adjustments can be made without departing from the basic technical concept of the present invention. For example, the configurations of the apparatuses and the elements and the representation modes of the data or the like illustrated in the individual drawings are merely used as examples to facilitate the understanding of the present invention. Thus, the present invention is not limited to the configurations illustrated in the drawings. For example, in the fourth example embodiment as described above, it is described that an intersection is designated as a boarding location, but a boarding location is not limited to an intersection.

Furthermore, in a further preferred example embodiment, a boarding assistance system is preferable to include an identification determination part for determining identification of a user of a passenger vehicle by matching an image shot by a fixed-point camera to an image of the user which the user has been registered in advance. Then, the on-board terminal can have a detection function of replacement of a passenger (impersonation, substitution) by the boarding assistance system displaying a determination result of the identification in addition to the information for identifying the user of the passenger vehicle on the on-board terminal or the like.

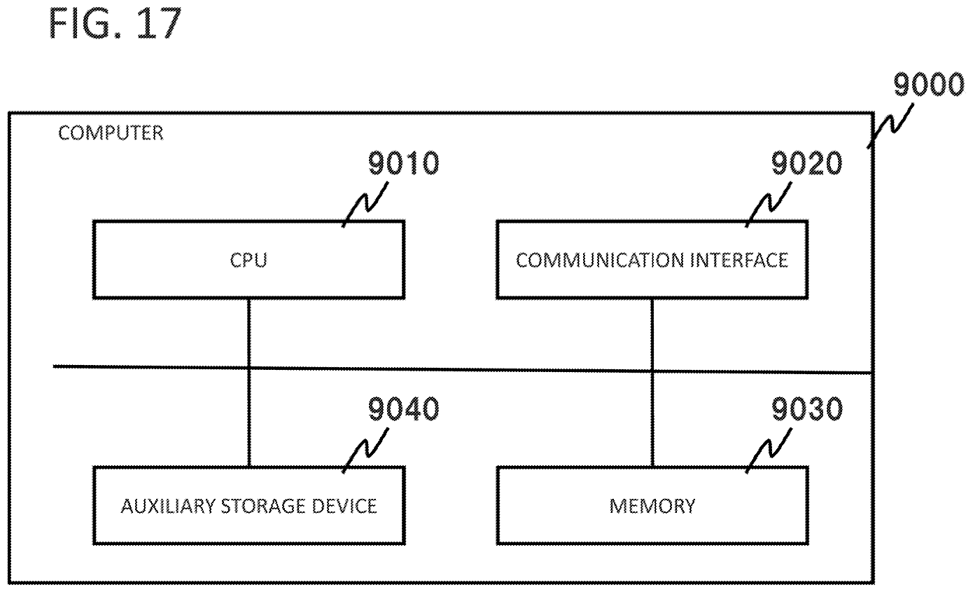

In addition, the procedures described in the above each example embodiment can each be realized by a program causing a computer (9000 in FIG. 17) functioning as the corresponding boarding assistance system to realize functions as the boarding assistance system. For example, this computer is configured to include a CPU (Central Processing Unit) 9010, a communication interface 9020, a memory 9030, and an auxiliary storage device 9040 in FIG. 17. That is, the CPU 9010 in FIG. 17 executes a user identification program and a data transmission program.

That is, the individual parts (processing means, functions) of each of an on-board terminal and a server as described above can each be realized by a computer program that causes a processor mounted on the corresponding apparatus to execute the corresponding processing described above by using corresponding hardware.

Finally, suitable modes of the present invention will be summarized.

### [Mode 1]

(See the boarding assistance system according to the above first aspect)

### [Mode 2]

The boarding assistance system as described above can have a configuration to display an appearance image of the user as the information for identifying the user.

### [Mode 3]

The boarding assistance system as described above can have a configuration to displays the feature information of the user as the information for identifying the user.

### [Mode 4]

The boarding assistance system as described above can have a configuration which further includes a waiting location identification part for identifying a location where the user is waiting based on a location of the fixed-point camera and a position of the user in the image shot by the fixed-point camera; and displays the waiting location as the information for identifying the user.

### [Mode 5]

The boarding assistance system as described above can have a configuration which further includes a boarding location prediction part for predicting a boarding location of the passenger vehicle to which the user is heading based on the location of the fixed-point camera and a travelling direction of the user, and displays the boarding location as the information for identifying the user.

### [Mode 6]

The boarding location prediction part of the boarding assistance system as described above can have a configuration to further predict an arrival time at the boarding location of the user based on the location of the fixed-point camera; and the boarding assistance system further includes an arrival time adjusting part for controlling at least one or more of one or more changes of one or more signal control parameters of one or more surrounding traffic light machines, a running route of the passenger vehicle, and a running speed thereof to cause the user to get on at the arrival time.

### [Mode 7]

The boarding assistance system as described above can have a configuration in which the image acquisition part selects the fixed-point camera based on a position information received from a terminal which user carries.

### [Mode 8]

The boarding assistance system as described above can have a configuration to select the fixed-point camera by matching the image shot by the fixed-point camera to an image of the user which the user has registered in advance.

### [Mode 9]

The boarding assistance system as described above can have a configuration which further includes an identification determination part for determining identification of the user of the passenger vehicle by matching the image shot by the fixed-point camera to an image of the user which the user has been registered in advance, and displays a determination result of the identification in addition to the information for identifying the user of the passenger vehicle.

### [Mode 10]

The boarding assistance system as described above can have a configuration which includes a function to display a traffic state around the boarding location of the user based on the image shot by the fixed-point camera in addition to the information for identifying the user of the passenger vehicle.

### [Mode 11]

The boarding assistance system as described above may be configured by a server which operates based on a request from an on-board terminal of the passenger vehicle.

### [Mode 12]

(See the boarding assistance method according to the above second aspect)

### [Mode 13]

(See the program according to the above third aspect)
The above modes 12 and 13 can be expanded to the modes 2 to 11 in the same way as the mode 1 is expanded.

The disclosure of each of the above PTLs is incorporated herein by reference thereto and may be used as the basis or a part of the present invention, as needed. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed to have been concretely disclosed. In addition, as needed and based on the gist of the present invention, the individual disclosed matters in the above literatures, as a part of the disclosure of the present invention, and partial or entire use of the individual disclosed matters in the above literatures that have been referred to in combination with what is disclosed in the present application, should be deemed to be included in what is disclosed in the present application.

### REFERENCE SIGNS LIST

10 boarding assistance system
11 reception part
12 image acquisition part
13 display part
20, 200 vehicle allocation system
30,300 fixed-point camera
40 display apparatus
50, 50a, 50b, 500, 500a user
100, 100a, 100b, 100c, 100d on-board terminal
100e server
101 reception part
102 image acquisition part
103, 103a, 103b, 103c, 103d display part
104 feature extraction part
105 waiting location determination part
106 boarding location prediction part
107 boarding location/time prediction part
103e transmission part
600 landmark
700 passenger vehicle
702 administration terminal
9000 computer
9010 CPU
9020 communication interface
9030 memory
9040 auxiliary storage device

What is claimed is:

1. A boarding assistance system, which can acquire one or more images from a plurality of fixed-point cameras installed on a roadside, comprising:
at least a processor; and
a memory in circuit communication with the processor,
wherein the processor is configured to execute program instructions stored in the memory to implement:
receiving a combination of information of a passenger vehicle which has been reserved by a user and information of the user who has reserved from a vehicle allocation system which allocates a passenger vehicle;
acquiring a shot image of the user who has reserved by selecting any of the fixed-point cameras based on the information of the user; and
displaying information for identifying the user of the passenger vehicle on a predetermined display apparatus using the shot image of the user.

2. The boarding assistance system according to claim 1,
wherein the information for identifying the user is an appearance image of the user.

3. The boarding assistance system according to claim 1, wherein the processor is configured to execute the program instructions to implement:
extracting feature information of the user from the shot image of the user, and
displaying the feature information of the user as the information for identifying the user.

4. The boarding assistance system according to claim 1, wherein the processor is configured to execute the program instructions to implement:
identifying a location where the user is waiting based on a location of the fixed-point camera and a position of the user in the image shot by the fixed-point camera; and
displaying the waiting location as the information for identifying the user.

5. The boarding assistance system according to claim 1, wherein the processor is configured to execute the program instructions to implement:
predicting a boarding location of the passenger vehicle to which the user is heading based on the location of the fixed-point camera and a travelling direction of the user, and
displaying the predicted boarding location as the information for identifying the user.

6. The boarding assistance system according to claim 5,
wherein the processor is configured to execute the program instructions to implement:
predicting an arrival time at the boarding location of the user based on the location of the fixed-point camera and a time at which the user has been shot by the fixed-point camera; and
controlling at least one or more of one or more changes of one or more signal control parameters of one or more surrounding traffic light machines, a running route of the passenger vehicle, and a running speed thereof to cause the user to get on at the arrival time.

7. The boarding assistance system according to claim 1,
wherein the processor is configured to execute the program instructions to implement:
selecting the fixed-point camera based on a position information received from a terminal which user carries.

8. The boarding assistance system according to claim 1,
wherein the processor is configured to execute the program instructions to implement:
selecting the fixed-point camera by matching the image shot by the fixed-point camera to an image of the user which the user has registered in advance.

9. The boarding assistance system according to claim 1, wherein the processor is configured to execute the program instructions to implement:
determining identification of the user of the passenger vehicle by matching the image shot by the fixed-point camera to an image of the user which the user has been registered in advance, and
displaying a determination result of the identification in addition to the information for identifying the user of the passenger vehicle.

10. The boarding assistance system according to claim 1,
wherein the processor is configured to execute the program instructions to implement:
displaying a traffic state around the boarding location of the user based on the image shot by the fixed-point camera in addition to the information for identifying the user of the passenger vehicle.

11. The boarding assistance system according to claim 1,
wherein the boarding assistance system is configured by a server which operates based on a request from an on-board terminal of the passenger vehicle.

12. A boarding assistance method, comprising:
by a computer which can acquire one or more images from a plurality of fixed-point cameras installed on a roadside,
receiving a combination of information of a passenger vehicle which has been reserved by a user and information of the user who has reserved from a vehicle allocation system which allocates a passenger vehicle;
acquiring a shot image of the user who has reserved by selecting any of the fixed-point cameras based on the information of the user; and
displaying information for identifying the user of the passenger vehicle on an on-board terminal of the passenger vehicle using the shot image of the user.

13. A computer-readable non-transitory recording medium recording a program, the program causing a computer which can acquire one or more images from a plurality of fixed-point cameras installed on a roadside, to perform processings of:
receiving a combination of information of a passenger vehicle which has been reserved by a user and information of the user who has reserved from a vehicle allocation system which allocates a passenger vehicle;
acquiring a shot image of the user who has reserved by selecting any of the fixed-point cameras based on the information of the user; and
displaying information for identifying the user of the passenger vehicle on an on-board terminal of the passenger vehicle using the shot image of the user.

14. The boarding assistance method according to claim 12,
wherein the information for identifying the user is an appearance image of the user.

15. The boarding assistance method according to claim 12, further comprising:
by the computer,
extracting feature information of the user from the shot image of the user, and
displaying the feature information of the user as the information for identifying the user.

16. The boarding assistance method according to claim 12, further comprising:
by the computer,
identifying a location where the user is waiting based on a location of the fixed-point camera and a position of the user in the image shot by the fixed-point camera; and
displaying the waiting location as the information for identifying the user.

17. The boarding assistance method according claim 12, further comprising:
by the computer,
predicting a boarding location of the passenger vehicle to which the user is heading based on the location of the fixed-point camera and a travelling direction of the user, and
displaying the predicted boarding location as the information for identifying the user.

18. The computer-readable non-transitory recording medium according to claim 13,
wherein the information for identifying the user is an appearance image of the user.

19. The computer-readable non-transitory recording medium according to claim 13,
wherein the program further causing the computer to perform processings of:
extracting feature information of the user from the shot image of the user, and
displaying the feature information of the user as the information for identifying the user.

20. The computer-readable non-transitory recording medium according to claim 13,
wherein the program further causing the computer to perform processings of:
identifying a location where the user is waiting based on a location of the fixed-point camera and a position of the user in the image shot by the fixed-point camera; and
displaying the waiting location as the information for identifying the user.
